(19) United States
(12) Patent Application Publication
(10) Pub. No.: US 2017/0164706 A1
(43) Pub. Date: Jun. 15, 2017

(54) Lighted Purse

(71) Applicant: Mark Fagan, Newark, DE (US)

(72) Inventor: Mark Fagan, Newark, DE (US)

(21) Appl. No.: 14/963,312

(22) Filed: Dec. 9, 2015

(51) Int. Cl. A45C 15/06; A45C 13/02; F21V 23/02; F21V 33/00; F21V 23/04; A45C 3/06; A45C 13/10

(52) U.S. Cl. CPC A45C 15/06; A45C 3/06; A45C 13/02; A45C 13/103; F21V 33/0004; F21V 23/04; F21V 23/023; F21Y 2101/02; F21Y 2105/006

(57) ABSTRACT

Disclosed herein is a lighted purse that provides light inside the purse as soon as the Zipper is pulled open and the purse remains in lighted condition until it is fully unzipped. The lighted purse is further embodied with the LED lights such that there is a set of LEDs at each side of the purse. The lighted purse is provided with components: two sets of LED lights, two battery packs for LED, two sets wires: 5 inches long and 3 inches wide, a sensor placed at the zipper. Also the LEDs are placed on each side of the purse, connected to reversible zipper.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention generally relates to an illumination system that can be incorporated into wearable items such as backpacks, waist packs, or clothing, as well as other outdoor articles. The lighting system can provide exterior illumination, interior illumination, or personal safety illumination.

(2) Background

Generally the baggage pieces come in a large variety of shapes, sizes and descriptions for serving a wide variety of purposes. A typical baggage piece, such as a purse, includes a shell having an exterior, and an interior into which items such as clothes, makeup compacts, wallets, writing instruments, and documents can be placed. An opening is provided to enable the user to obtain access to the interior of the purse. A closure element such as a clamp, clasp or zipper is provided to selectively seal and unseal the opening. A handle or strap is also provided to enable the user to better carry the purse or baggage piece.

One difficulty faced by the users of baggage pieces in general, and purses in particular is finding items in the interior of the purse. For many purses, the openings are not sufficiently large to enable a great deal of light to enter the interior of the purse. Thus, even when the opening of the purse is unsealed, the light traveling into the interior of the purse is usually insufficient to illuminate all of the items inside the purse. Especially difficult to illuminate are items placed at or close to the bottom of the interior of the purse such bottom dwelling items are often covered by other items resting on top of them. Shadows in the purse, even in bright light and especially in darkened areas, can cause items to be misplaced or difficult to find within the bag, particularly small items such as keys and coins. As will be appreciated, finding these bottom dwelling items, requires the user to open the purse and fish through its contents until the desired item is found. Often, this desired item is found not by the user sighting the item, but rather by the user fishing around until she feels the desired item.

To alleviate this difficulty encountered by purse users, several devices have been invented that incorporate a light source into the interior of the purse.

Various purses with lighted apparatus have been disclosed in the prior art including:

U.S. Pat. No. 6,447,142 issued to Weir describes a purse light system. The purse light system is a purse with a built-in light system, which includes a purse outer structure, a battery pack and a light assembly positioned to emit light into the purse chamber. The purse lighting system automatically switches on when the purse opening is in the open position and off when the purse opening is in the closed position. This invention lights the purse from the top of the purse.

Another purse lighting system, U.S. Pat. No. 5,424,926 issued to Meyers describes a purse light. This purse light includes a light for illuminating the interior of a purse, consisting of a mounting assembly housing a light bulb, a reflector to direct the light towards a diffusing lens which projects the light in a multitude of directions and a digital clock.

U.S. Pat. No. 6,508,568 issued to Blue-Recio discloses yet another light assembly for the interior of a purse. This light assembly consists of a mounting structure to secure the assembly to the inside of a bag, an illumination source which projects light to the interior of the bag, and a switch the user must push to turn the purse light on. The switching means for the '598 patent may allow for the lamp to be inadvertently switched on by pressure from items within the purse and may also allow for the lamp to be inadvertently left on by the user, both instances may result in complete discharge of the battery without the knowledge of the user.

U.S. Pat. No. 4,742,438 issued to King describes a light for the interior of a purse, having a light bulb, an electric power supply mounted within a translucent housing which is temporarily mounted on a mounting bracket which is permanently attached to the inside of a purse. The '438 patent is cumbersome and impractical because it requires mounting brackets to be permanently mounted on the interior of a purse.

U.S. Pat. No. 2002/0067610 to Marshal discloses a lighted and content-organizing carrying case for illuminating the main compartment and organizing the contents in the carrying case. The lighted and content-organizing carrying case includes a handbag assembly and also includes light-emitting assemblies removably attached to the bag.

U.S. Pat. No. 4,992,704 to Stinson discloses a light emitting diode (LED) or lamp that is programmable to emit a variety of colors or hues at the selection of the user having a unitary housing of clear molded solid epoxy supporting three light dies characterized as producing color hues of red, green and blue respectively. A common cathode is supported in the housing and wire leads interconnect the anode of each light die with the common cathode. Control circuits are operably coupled to anode leads and a common cathode lead for selectively energizing the light die anodes so that their respective color outputs visually combine to produce a desired color or hue.

The foregoing patents reflect the state of the art of which the applicant is aware and are tendered with the view toward discharging applicant's acknowledged duty of candor in disclosing information which may be pertinent in the examination of this application. It is respectfully stipulated, however, that none of these patents teach or render obvious, singly or when considered in combination, applicant's claimed invention.

Therefore, a long-standing need has existed to provide a novel means by which the purse can be effectively lighted as soon as the zipper is opened. There is further a need of such an arrangement of lighting a purse that stays until the purse is re-zipped.

Thus, a better lighting arrangement for purse, solving the aforementioned problems is desired.

### BRIEF SUMMARY OF THE INVENTION

The invention is an improvement to baggage product enabling user to be able to find anything in their baggage. The invention is a lighted baggage like purse or handbag or clutch or backpack etc., as soon as the user start to pull the zipper to open on the purse the lights starts to come on till it is fully unzipped.

The primary objective of the invention is to provide a means for a user to have a bag with an illuminated interior for better visibility while accessing the bag.

According to primary aspect of the present invention, a lighted purse that provides light inside the purse as soon as the Zipper is pulled open and the purse remains in lighted condition until it is fully unzipped.

It is another object of the present invention to provide a lighted purse embodied with the LED lights.

According to an objective, the invention is a baggage interior part illuminating system comprising a baggage body having a plurality of walls defining an interior compartment inside the baggage body, a securing member with an open/close means placed within the baggage body in a closed position enclosing the interior compartment or an open position allowing access to the interior compartment and an illuminating unit located inside the interior compartment, the illuminating unit having at least one sources of light disposed on a light panel.

In another objective of the invention the baggage body of the baggage comprise of at least one exterior surface, at least one interior surface and at least one top edge that will open and close to allow access to an interior compartment inside the baggage body.

Furthermore, the invention was created with simplicity in mind. It is being created to be the simplest and most efficient universal way to light a purse keeping in mind the convenience of user and best utilization of space inside a purse. All attributes discussed could be necessary to the function of this invention.

The summary is provided to introduce a selection of concepts in a simplified form that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 shows a perspective view of with LED panels used in the illumination of a baggage, according to the present invention.

### DETAILED DESCRIPTIONS OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

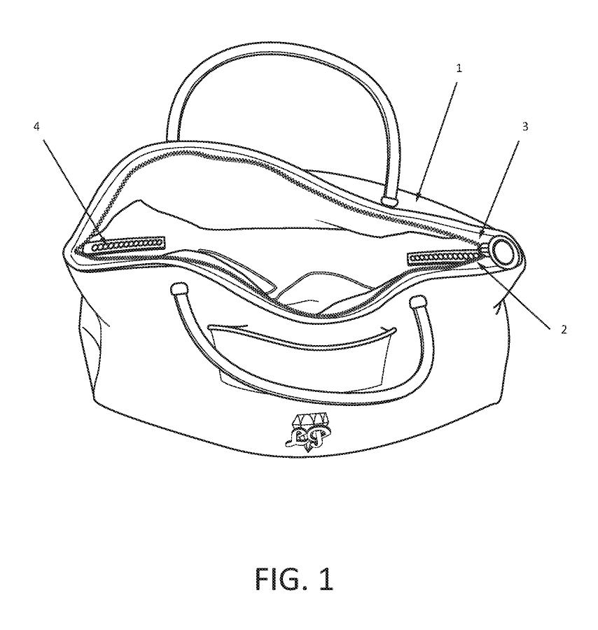

Referring to the drawings, more specifically to FIG. 1 illustrates a perspective view of the lighted purse with Nickel Zipper 2 on the top closing edge 3 of the purse. There is an arrangement of two LED panels 4 at the both sides of the purse. The LED panels are embodied with the battery packs and connected using the 5 inches long and 3 inches wide wires at both sides of the purse. The LED is lighted with the movement of the Zipper such that the LEDs remain in lighted state until the time when the purse is re-zipped.

In one embodiment of the drawings a baggage interior part illuminating system comprising a baggage body having a plurality of walls defining an interior compartment inside said baggage body, a securing member with an open/close means placed within said baggage body in a closed position enclosing said interior compartment or an open position allowing access to said interior compartment and an illuminating unit located inside said interior compartment, said illuminating unit having at least one sources of light disposed on a light panel.

In another embodiment the baggage body comprises of an exterior surface, an interior surface and a top edge that will open and close to allow access to an interior compartment inside said baggage body. Moreover the securing member is attached to said top edge of said baggage and is Zipper.

Further in another embodiment, the illuminating unit located inside said interior compartment comprises of a sources of light and a source of electrical power. Moreover the sources of light connected to said source of electrical power and the source of electrical power operatively connected to said open/close means. The sources of light emit light from said sources of light when said purse body is in said open position and turn off said sources of light when said purse body is in said closed position.

In yet another embodiment, said illumination system further comprise of a switch means operatively coupled to the power source means, an electroluminescent flexible panel and a light emitting diode as interior illumination source. Moreover, the system further comprises a circuit board for electrical connection and electrical power like a replaceable battery source.

In one embodiment of the invention, lighted purse is provided with components: two sets of LED lights, 2 battery packs for LED, two sets wires: 5 inches long and 3 inches wide, a sensor placed at the Zipper. Also the LEDs are placed on each side of the purse, connected to reversible Zipper.

In a preferred embodiment of the present invention the lighted purse includes LEDs that are used to generate a pattern of light. The use of light emitting fabrics that are soft and pliable and add very little to the total weight of the purse. In another embodiment of the invention the light arrangement includes the use of electroluminescent (EL) wires that produce a continuous line of light that may be extended from the inside to the outside of the purse.

The purse of the invention can be selected from quality leather, but not limited to, and with nickel hardware and additional compartments inside. The hardware includes Zipper and zip line made of nickel and the like metals or plastic. The Zipper used is reversible Zipper connected to the two set of LED lights such that at any point whenever the purse is unzipped the lights go on inside.

In a preferred embodiment of the invention a sensor is provided at the Zipper to make the light arrangement turn on, once the Zipper is pulled back or zip is opened.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A baggage interior part illuminating system comprising:
a baggage body having a plurality of walls defining an interior compartment inside said baggage body;
a securing member with an open/close means placed within said baggage body in a closed position enclosing said interior compartment or an open position allowing access to said interior compartment; and
an illuminating unit located inside said interior compartment, said illuminating unit having at least one sources of light disposed on a light panel.

2. A baggage interior part illuminating system as set forth in claim 1, wherein said baggage body further comprises:
an exterior surface;
an interior surface; and
a top edge with open and close means to allow access to an interior compartment inside said baggage body.

3. A baggage interior part illuminating system as set forth in claim 1, wherein said securing member is attached to said top edge of said baggage body.

4. A baggage interior part illuminating system as set forth in claim 1, wherein said securing member is a zipper.

5. A baggage interior part illuminating system as set forth in claim 1, wherein said illuminating unit located inside said interior compartment comprise:
a sources of light; and
electrical power means.

6. A baggage interior part illuminating system as set forth in claim 1, wherein said sources of light connected to said electrical power means.

7. A baggage interior part illuminating system as set forth in claim 1, wherein said electrical power means operatively connected to said open/close means.

8. A baggage interior part illuminating system as set forth in claim 1, wherein said sources of light emit light from said sources of light when said purse body is in said open position and turn off said sources of light when said purse body is in said closed position.

9. A baggage interior part illuminating system as set forth in claim 1, wherein said interior illumination source is a light emitting diode.

10. A baggage interior part illuminating system as set forth in claim 1, wherein said interior illumination source is an electroluminescent flexible panel.

11. A baggage interior part illuminating system as set forth in claim 1, wherein said illumination system further comprise of a switch means operatively coupled to the power source means.

12. A baggage interior part illuminating system as set forth in claim 1, wherein said switch means is attached to said zipper.

13. A baggage interior part illuminating system as set forth in claim 1, wherein said illumination system further comprises a circuit board for electrical connection.

14. A baggage interior part illuminating system as set forth in claim 1, wherein said electrical power means is a battery source.

15. A baggage interior part illuminating system as set forth in claim 1, wherein said battery source further comprises at least one replaceable battery.
